(19) United States
(12) Patent Application Publication
(10) Pub. No.: US 2020/0401108 A1
(43) Pub. Date: Dec. 24, 2020

(54) MACHINING CONTROL DEVICE AND MACHINE TOOL

(71) Applicant: FANUC CORPORATION, Yamanashi (JP)

(72) Inventor: Norihiko ZAIMA, Yamanashi (JP)

(73) Assignee: FANUC CORPORATION, Yamanashi (JP)

(21) Appl. No.: 16/880,292

(22) Filed: May 21, 2020

(30) Foreign Application Priority Data
Jun. 18, 2019 (JP) 2019-112704

(51) Int. Cl. G05B 19/414; G05B 19/406; G05B 19/4093

(52) U.S. Cl. CPC G05B 19/414; G05B 2219/36219; G05B 19/4093; G05B 19/406

(57) ABSTRACT

A machining control device according to an aspect of the present disclosure includes: a machining step extraction unit that analyzes a machining program to extract a plurality of machining steps in each of which a feed rate of a tool is changeable; a precedence setting unit that sets precedence to the machining steps extracted by the machining step extraction unit; a machining time period calculation unit that calculates a machining time period of each of the machining steps based on the machining program; and a set value changing unit that changes set values of the feed rates of the tools in descending order of the precedence set by the precedence setting unit such that a sum of the machining time periods calculated by the machining time period calculation unit approaches a target value.

This application is based on and claims the benefit of priority from Japanese Patent Application No. 2019-112704, filed on 18 Jun. 2019, the content of which is incorporated herein by reference.

### BACKGROUND OF THE INVENTION

### Field of the Invention

The present invention relates to a machining control device and a machine tool.

### Related Art

A machine tool such as a machining center is controlled by a machining control device such as a numerical control device, and automatically carries out a plurality of machining steps in which one or more workpieces are machined in order according to a machining program. When such a machine tool is caused to execute a machining program including a large number of machining steps, it is not easy to predict the time at which the machining will be completed.

For example, when a machine tool works without human intervention at night, it is desirable that the machine tool be ready to perform a new machining process at the time when an operator comes to work in the morning. If a machining process which can be completed well before the morning is selected and performed by a machine tool, the temperature of parts of the machine tool decreases before a new machining process is begun in the morning. When the temperature of the machine tool rises after a machining process has been begun, a machining error occurs due to thermal displacement. For this reason, in the case where the temperature of a machine tool is low, it is desirable to perform warm-up operation to raise the temperature of the machine tool prior to performing a machining process. If the completion time of such nighttime machining can be set to be immediately before the time at which the operator comes to work, the warm-up operation can be omitted and the operating rate can be improved consequently. Therefore, there has been a demand for a machine tool whose machining time period can be easily adjusted.

As a technique to adjust a machining time period, Patent Document 1 discloses a “device for automatically creating and evaluating machining information, the device including: a machining time period calculation unit that creates a tool trajectory, and calculates a machining time period from determined machining conditions and the created tool trajectory; and a feedback processing unit that automatically corrects at least one piece of the machining information determined by determination units and the machining time period calculation unit, and provides feedback to the corresponding determination unit or the machining time period calculation unit, so that the calculated machining time period satisfies a target value.”

Patent Document 1: Japanese Unexamined Patent Application, Publication. No. H11-129141

### SUMMARY OF THE INVENTION

The device disclosed in Patent Document 1 calculates a machining time period, changes a machining speed within the range from a recommended machining speed to a maximum machining speed, and changes a tool feed rate within the range from a recommended feed rate to a maximum feed rate, so that the calculated machining time period satisfies the target machining time period. Patent Document 1 discloses that an increase in the machining speed and the tool feed rate reduces the tool life. However, such an increase in the machining speed and the tool feed rate may also results in a decrease in machining accuracy. When there are two or more machining steps, the machining steps include a machining step in which a decrease in machining accuracy due to the machining speed and the tool feed rate is likely to cause a problem, and a machining step in which such a decrease in machining accuracy is unlikely to cause a problem. If machining conditions are changed without taking account of these circumstances as in Patent Document 1, products may be obtained with insufficient accuracy. Thus, a machining control device has been needed which is capable of adjusting the machining time period while inhibiting a decrease in machining accuracy.

A machining control device according to an aspect of the present disclosure includes: a machining step extraction unit that analyzes a machining program to extract a plurality of machining steps in each of which a feed rate of a tool is changeable; a precedence setting unit that sets precedence to the machining steps extracted by the machining step extraction unit; a machining time period calculation unit that calculates a machining time period of each of the machining steps based on the machining program; and a set value changing unit that changes set values of the feed rates of the tools in descending order of the precedence set by the precedence setting unit such that a sum of the machining time periods calculated by the machining time period calculation unit approaches a target value.

The machining control device according to the present disclosure is capable of adjusting a machining time period while inhibiting a decrease in machining accuracy.

### BRIEF DESCRIPTION OF THE DRAWINGS

FIG. 1 is a schematic diagram showing the configuration of a machine tool according to an embodiment of the present disclosure;

FIG. 2 shows, as an example, a screen displayed by a display unit of a machining control device shown in FIG. 1;

FIG. 3 is a flowchart showing a procedure by which a set value changing unit of the machining control device of FIG. 1 adjusts machining time periods; and

FIG. 4 is a flowchart showing the details of the machining time period calculating step shown in the flowchart of FIG. 3.

### DETAILED DESCRIPTION OF THE INVENTION

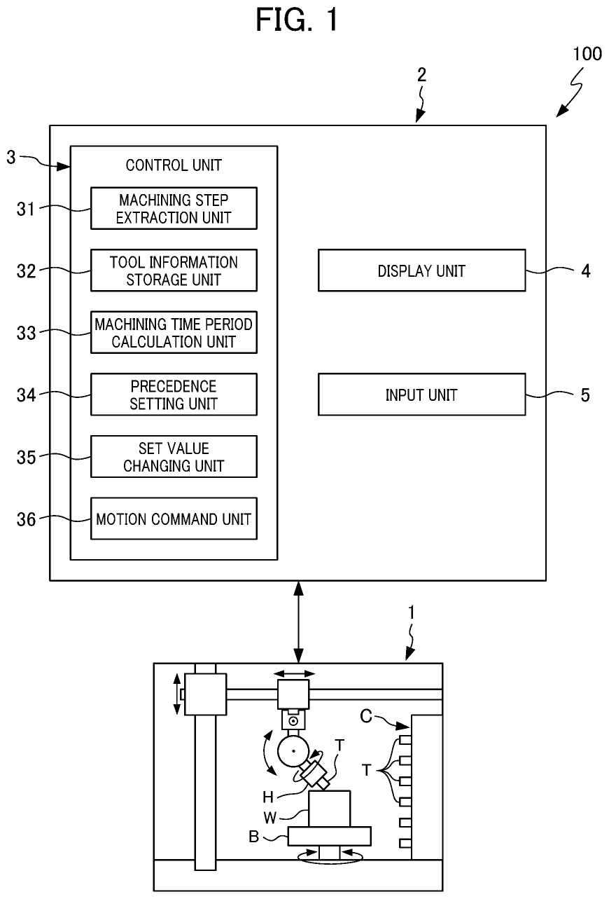

An embodiment of the present disclosure will be described below with reference to the drawings. FIG. 1 is a schematic diagram showing the configuration of a machine tool 100 according to an embodiment of the present disclosure. The machine tool 100 includes a machining apparatus 1 and a machining control device 2 for controlling the machining apparatus 1. The machining control device 2 is an embodiment of the machining control device according to the present disclosure.

The machining apparatus 1 can be embodied as, for example, an apparatus that cuts a workpiece W held on a table B, using a tool T held by a machining head H. The machining apparatus 1 can have a configuration including a plurality of drive shafts for moving the table B and the machining head H relative to each other, and a tool replacement device C for replacing the tool T held by the machining head H. The plurality of drive shafts of the machining apparatus 1 are not limited to a particular shaft configuration. For example, the plurality of drive shafts can include a main shaft that rotates the machining head H (tool T), three shafts that are arranged orthogonal to each other and move the machining head H relative to the table B, and a plurality of rotary shafts that tilt the main shaft.

The machining control device 2 controls the motion of each of the drive shafts of the machining apparatus 1, according to a machining program. Typically, the machining control device 2 can be constituted by a numerical control device attached to the machining apparatus 1. Alternatively, the machining control device 2 may be constituted by a management server which is partially or entirely separated from the numerical control device of the machining control device 2, and which manages one or more numerical control devices. Further, part or the entirety of the machining control device 2 may be shared by a plurality of machine tools.

The machining control device 2 can be configured to include a control unit 3, a display unit 4 and an input unit 5. The control unit 3 can be implemented by a computer device including a CPU, a memory, etc., and having an appropriate control program. loaded therein. The display unit 1 may be constituted by, for example, a liquid crystal display panel, an organic EL display panel or the like. The input unit 5 may be constituted by, for example, a keyboard, a mouse, a touch sensor or the like. The display unit 4 and the input unit 5 may be integral with each other in the form of, for example, a touch panel.

The control unit 3 includes: a machining step extraction unit 31 that analyzes a machining program to extract a plurality of machining steps in each of which a feed rate of a tool T can be changed; a tool information storage unit 32 that stores a minimum value and a maximum value of the feed rate which are settable for each tool T; a machining time period calculation unit 33 that calculates a machining time period of each of the machining steps based on the machining program; a precedence setting unit 34 that sets precedence to the machining steps extracted by the machining step extraction unit 31; a set value changing unit 35 that changes set values of the feed rates of the tools T in descending order of precedence set by the precedence setting unit 34 such that the sum of the machining time periods calculated by the machining time period calculation unit 33 approaches a target value; and a motion command unit 36 that gives a command to the drive shafts of the machining apparatus 1 such that the tool T moves at a feed rate changed by the set value changing unit 35. The machining step extraction unit 31, the tool information storage unit 32, the machining time period calculation unit 33, the precedence setting unit 34, the set value changing unit 35 and the motion command unit 36 are distinguishable from each other in terms of function, and do not need to be clearly distinguishable from each other in terms of mechanical structure and program structure.

The machining step extraction unit 31 analyzes the machining program to extract machining steps in each of which the feed rate of the tool can be changed independently. Specifically, the machining step extraction unit 31 may divide the machining program into a plurality of machining steps, while setting tool replacement commands as start points of the plurality of machining steps. The machining step extraction unit 31 may extract the machining steps by dividing the machining program, while setting, as start points, an auxiliary command such as an M code and a statement such as a break point, in addition to the tool replacement commands. If the machining program includes a subprogram, the subprogram may be treated as one consisting of one or more machining steps.

The tool information storage unit 32 stores the minimum and maximum values of the feed rate that are settable for each of the tools T. The tool information storage unit 32 may store, as the minimum and maximum values of the feed rate of each tool T, catalogue values of the tool T.

The tool information storage unit 32 stores order of precedence for changing the feed rate, the precedence being set to each tool T. The tools T may differ from one another in the assigned precedence. However, it is practical to sort the plurality of tools T into two or more groups that differ in the precedence. Specifically, for example, the tool information storage unit 32 may be configured to sort the plurality of tools T into three groups including a first-highest precedence group for use in roughing, a second-highest precedence group for use in semi-finishing, and a low-precedence group for use in finishing. By assigning such higher precedence to the roughing, influence of a change of the feed rate on the machining accuracy of the final product can be reduced. Accordingly, the tool information storage unit 32 can be configured to store a numerical value indicating the precedence given to each tool T or a parameter assigned to any of the plurality of groups differing in the precedence.

The machining time period calculation unit 33 calculates the machining time period of each of the machining steps in an individual manner, based on the machining program. Specifically, for a plurality of blocks of the machining steps resulting from the division of the machining program, the machining time period calculation unit 33 calculates a moving distance by which the tool T moves, divides the moving distance by the feed rate of the tool T, and thereby calculates a machining time period of each of the blocks.

Further, for each machining step, the machining time period calculation unit 33 calculates a machining time period in a case where the feed rate of the tool T is set to the minimum value stored in the tool information storage unit 32, and a machining time period in a case where the feed rate of the tool T is set to the maximum value stored in the tool information storage unit 32, in the same manner.

The precedence setting unit 34 sets precedence to each of the machining steps extracted by the machining step extraction unit 31. This precedence can be determined in correspondence with the tool T to be used in the machining step. In other words, a configuration is possible in which the precedence of each machining step is set in accordance with the precedence of the tool T stored in the tool information storage unit 32.

The set value changing unit 35 changes the set values of the feed rates of the tools T in descending order of precedence of the machining steps, so that the sum of the machining time periods approaches the target value. The target value may be described in the machining program, or may be inputted by a user by way of the input unit 5. Alternatively, the target value may be given as machining completion time. In this case, the machining time periods and the machining completion time can be mutually converted, with reference to an internal clock of the control unit 3.

The set value changing unit 35 may select, as the feed rate of the tool T, any value within the range from the minimum value to the maximum value stored in the tool information storage unit 32. Alternatively, the set value changing unit 35 may change the feed rate of the tool T to the minimum value or the maximum value so that the sum of the machining time periods approaches the target value. Configuring the set value changing unit 35 to select the minimum value or the maximum value makes it possible to reduce the computing load of the control unit 3.

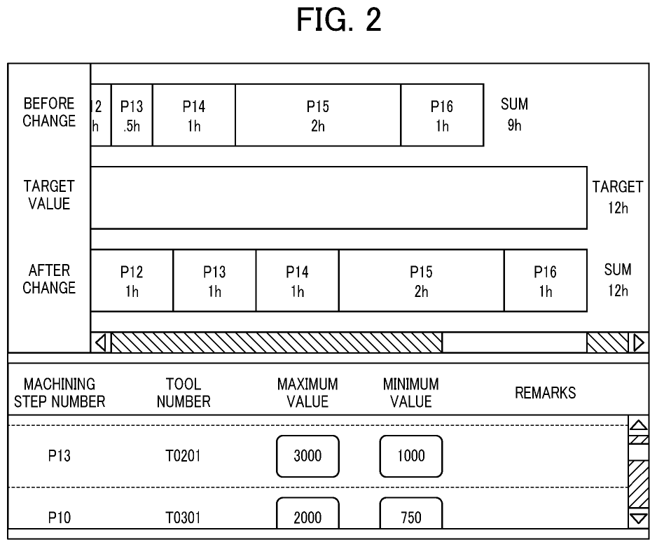

The set value changing unit 35 may be configured to automatically change the set values of the feed rates of the tools T to adjust the sum of the machining time periods. Alternatively, the set value changing unit 35 may be configured: to present, to the user, the respective machining time periods of the machining steps calculated by the machining time period calculation unit 33 and the sum of the machining time periods by way of the display unit 4, as shown as an example in FIG. 2; and to change the feed rates of the tools T in accordance with input given via the input unit 5 by the user. This feature in which the user specifies the feed. rates of the tools T enables experience of the user to be reflected, whereby appropriate setting of the feed rates can be achieved, which setting has a smaller influence on the machining accuracy.

The user may change the feed rate by selecting one of the displayed minimum and maximum values. Thus, the user can easily adjust the machining time period by changing the feed rate. In the example shown in FIG. 2, items related to setting of the feed rates are displayed on a machining step-by-machining step basis, in order of precedence and in a scrollable manner. In this display example, the following are displayed for each machining step: the machining step number, the tool number of the tool to be used in the machining step, the maximum value of the feed rate stored in the tool information storage unit 32, and the minimum value of the feed rate stored in the tool information storage unit 32. In this display example, each of the maximum and minimum values of the feed rate is displayed as a button selectable by the user.

The set value changing unit 35 may display a maximum value and a minimum value of the machining time period corresponding to the minimum value and the maximum value of the feed rate, on a machining step-by-machining step basis. Further, the set value changing unit 35 may be configured to calculate a corresponding feed rate from a numerical value between the maximum value and the minimum value of the machining time period inputted by the user. Thus, converting the feed rates into the machining time periods to be managed by the user allows the user to adjust the machining time periods more easily.

The set value changing unit 35, which changes the feed rates, may be configured to further present information on tools compatible with the tool specified in the machining program so that the specified tool can be replaced with another tool. This configuration makes it possible to extend the range of adjustment of the machining time periods.

When the user changes the feed rates of the tools T, the set, value changing unit 35 preferably immediately displays, by way of the display unit 4, the sum of the machining time periods that reflects the change so that the user can confirm the result. When the user intends to change the feed rates of the tools T, the set value changing unit 35 prompts the user to change the feed rates in descending order of precedence of the machining steps. However, the set value changing unit 35 may permit the user to change not the feed rate of the machining step presented as one with the highest precedence, but the feed rate of a different machining step presented as one with the second highest precedence. In this case, it is interpreted that the set value changing unit 35 has performed processing of changing the feed rates of the tools T in descending order of precedence. In other words, changing the feed. rate does not require that the associated numerical value be changed actually, but rather means that the processing related to the change is performed.

The motion command unit 36 generates drive commands to move the respective drive shafts of the machining apparatus 1 under conditions where the change in the feed rates of the tools T made by the set value changing unit 35 is reflected to the machining program. The motion command unit 36 can have the same configuration as a configuration for generating drive commands in a known numerical control device.

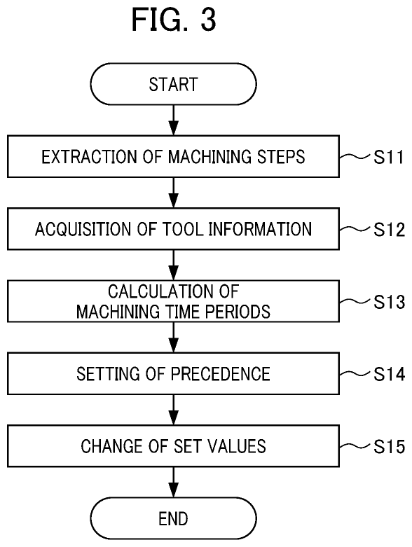

FIG. 3 shows a procedure by which the machining control device 2 adjusts the machining time periods. The adjustment of the machining time periods by the machining control device 2 includes: a step of extracting a plurality of machining steps in each of which the feed rate of the tool T can be changed, by analyzing a machining program (Step S11: machining step extracting step); a step of acquiring tool information including the minimum value and the maximum value of the feed rate of each tool T from the tool information storage unit 32 (Step S12: tool information acquiring step); a step of calculating the machining time period of each of the machining steps based on the machining program (Step S13: machining time period calculating step); a step of setting precedence to the machining steps (Step S14: precedence setting step); and a step of changing the set values of the feed rates of the tools T in descending order of precedence (Step S15: set value changing step).

### Machining Step Extracting Step

In Step S11 as the machining step extracting step, the machining step extraction unit 31 extracts the plurality of machining steps from the machining program.

### Tool Information Acquiring Step

In Step S12 as the tool information acquiring step, the machining time period calculation unit 33 acquires, from the tool information storage unit 32, the maximum and minimum values of the feed rate of each of the tools T to be used in the machining steps.

### Machining Time Period Calculating Step

In Step S13 as the machining time period calculating step, the machining time period calculation unit 33 calculates: a machining time period in a case where the feed rate of the tool T is set to the feed rate described in the machining program; a machining time period in a case where the feed rate is set to the minimum. value acquired from the tool information storage unit 32; and a machining time period in a case where the feed rate is set to the maximum value acquired from the tool information storage unit 32, based on the machining program.

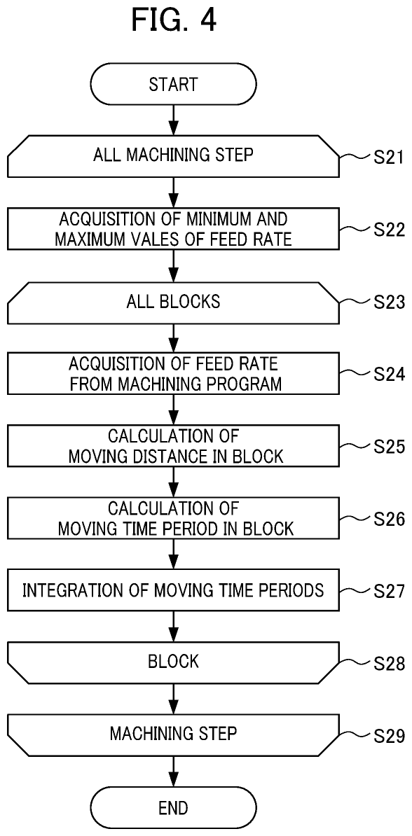

FIG. 4 shows the details of the calculation of the machining time period, the calculation performed in the machining time period calculating step. The machining time period calculating step includes: a step of setting, in order, the plurality of machining steps to be subjected to the calculation, the step being a start point from which repetitive processing is repeatedly performed on the plurality of machining steps (Step S21); a step of acquiring the maximum and minimum values of the feed rate of one of the machining steps that is under processing (Step S22); a step of setting, in order, a plurality of program blocks that are included in the machining step and to be processed, the step being a start point from which repetitive processing is repeatedly performed on the plurality of program blocks (Step S23); a step of acquiring an initial value of the feed rate of one of the blocks that is under processing, the initial value being described in the machining program (Step S24); a step of calculating a moving distance by which the tool T moves in the one of the blocks that is under processing (Step S25); a step of calculating a moving time period during which the tool T moves in the one of the blocks that is under processing (step S26); a step of integrating the calculated moving time periods (Step S27); a step of determining to return to Step S23 until the processing of the final block is completed, the step being the end point of the repetitive processing performed on the plurality of blocks (Step S28); and a step of determining to return to Step S21 until the processing of the final machining step is completed, the step being the end point of the repetitive processing performed on the plurality of machining steps (Step S29).

### Precedence Setting Step

In Step S14 as the precedence setting step, the precedence setting unit 34 sets precedence to each of the machining steps.

### Set Value Changing Step

In Step S15 as the set value changing step, the set value changing unit 35 changes the set values of the feed rates of the tools T of the machining steps in descending order of precedence.

The machining control device 2, of which the set value changing unit 35 changes the set values of the feed rates of the tools T in descending order of precedence of the machining steps, can adjust the sum of the machining time periods required to complete all the machining processes described in the machining program so as to make the sum approach the target value, while inhibiting a decrease in the machining accuracy.

In particular, the feature in which the set value changing unit 35 presents the sum of the machining time periods to the user and allows the user to change the feed rates of the tools in descending order of precedence of the machining steps enables experience of the user to be taken into account, thereby further inhibiting a decrease in the machining accuracy.

The embodiment of the present invention has been described in the foregoing. However, the present invention is not limited to the embodiment described above. In the above embodiment, the most preferable effects exerted by the present invention have merely been described. The effects of the present invention are not limited to those described in the embodiment.

The machining control device according to the present disclosure may be configured to make the sum of the machining time periods equal to the target value, or may be configured to adjust the sum of the machining time periods within a certain range which is set based on the target value as a reference (e.g., within a range equal to or below the target value, wherein a difference between the range and the target value is equal to or less than a predetermined value).

The set value changing unit of the machining control device according to the present disclosure may be configured to change the set value of the feed rates of the machining steps having the same precedence to the respective maximum or minimum values in a collective manner, or to respective values between the minimum and maximum values and at the same ratio.

### EXPLANATION OF REFERENCE NUMERALS

1: Machining Apparatus
2: Machining Control Device
3: Control Unit
4: Display Unit
5: Input Unit
31: Machining Step Extraction Unit
32: Tool information Storage Unit
33: Machining Time Period Calculation Unit
34: Precedence Setting Unit
35: Set Value Changing Unit
100: Machine Tool

What is claimed is:

1. A machining control device comprising:
a machining step extraction unit that analyzes a machining program to extract a plurality of machining steps in each of which a feed rate of a tool is changeable;
a precedence setting unit that sets precedence to the machining steps extracted by the machining step extraction unit;
a machining time period calculation unit that calculates a machining time period of each of the machining steps based on the machining program; and
a set value changing unit that changes set values of the feed rates of the tools in descending order of the precedence set by the precedence setting unit such that a sum of the machining time periods calculated by the machining time period calculation unit approaches a target value.

2. The machining control device according to claim 1, wherein
the set value changing unit presents the sum of the machining time periods of the machining steps calculated by the machining time period calculation unit to a user, and changes the set values of the feed rates of the tools according to input by the user.

3. The machining control device according to claim 2, further comprising:
a tool information storage unit that stores a minimum value and a maximum value of the feed rate which are settable for each of the tools, wherein
the set value changing unit displays the minimum value and the maximum value of the feed rate which are settable for each of the tools.

4. The machining control device according to claim 3, wherein
the set value changing unit is configured to change the set values of the feed rate in response to selection of one of the displayed minimum and maximum values by the user.

5. A machine tool comprising:
the machining control device according to claim 1; and
a machining apparatus controllable by the machining control device.
